(19) United States
(12) Patent Application Publication
(10) Pub. No.: US 2011/0217621 A1
(43) Pub. Date: Sep. 8, 2011

(54) PROCESS TO PRODUCE CATALYST COATED MEMBRANES FOR FUEL CELL APPLICATIONS

(75) Inventors: Vinci Martinez Felix, Kennett Square, PA (US); Wayne Herman Smiley, Wilmington, DE (US)

(73) Assignee: E. I. DU PONT DE NEMOURS AND COMPANY

(21) Appl. No.: 13/129,014

(22) PCT Filed: Dec. 23, 2009
(86) PCT No.: PCT/US09/69366

§ 371 Date: May 12, 2011

Related U.S. Application Data
(60) Provisional application No. 61/140,191, filed on Dec. 23, 2008.

(51) Int. Cl. H01M 8/10; B05D 5/12

(52) U.S. Cl. 429/492; 427/211; 427/77

(57) ABSTRACT

A process for forming a catalyst coated membrane by placing layered sandwich between two synchronously-driven, resilient, thermally conductive belts and transferring completely a first electrocatalyst layer adhered to a first flexible substrate and a second electrocatalyst layer adhered to a second flexible substrate to ionomeric polymer membrane.

### FIELD

Disclosed is a process for production of catalyst coated membranes (CCMs) for use in electrochemical cells, including proton exchange membrane fuel cells, sensors, electrolyzers and chloro-alkali separation membranes.

### BACKGROUND

A variety of electrochemical cells falls within a category of cells often referred to as solid polymer electrolyte (SPE) cells. A SPE cell typically employs a membrane of a cation exchange polymer, also known as the “ionomeric polymer membrane”, that serves as a physical separator between an anode and a cathode, while also serving as an electrolyte. SPE cells can be operated as electrolytic cells for the production of electrochemical products or they may be operated as fuel cells. SPE fuel cells typically also comprise a porous, electrically conductive sheet material that is in electrical contact with each of the electrodes, and permit diffusion of the reactants to the electrodes. In fuel cells that employ gaseous reactants, this porous, conductive sheet material is sometimes referred to as a gas diffusion layer and can be made of a carbon fiber paper or carbon cloth. An assembly which includes the membrane, the anode and the cathode, and the gas diffusion layers for each electrode, is sometimes referred to as a membrane electrode assembly (MEA). Bipolar plates, made of a conductive material and providing flow fields for the reactants, are placed between adjacent MEAs. A number of MEAs and bipolar plates are assembled in this manner to provide a fuel cell stack.

For the electrodes to function effectively in SPE fuel cells, effective electrocatalyst sites must be provided. Effective electrocatalyst sites have several desirable characteristics: (1) the electrocatalyst sites must be accessible to the reactant gas or liquid, (2) the sites must be electrically connected to the gas diffusion layer, and (3) the sites must be ionically connected to the fuel cell electrolyte. In order to improve ionic conductivity, ion exchange polymers are often incorporated into the electrodes. In addition, incorporation of ion exchange polymer into the electrodes can also have beneficial effects with liquid feed fuels. For example, in a direct methanol fuel cell, ion exchange polymer in the anode makes it more wettable by the liquid feed stream in order to improve access of the reactant to the electrocatalyst sites.

Two approaches have been taken to form electrodes for SPE fuel cells. In one, the electrodes are formed on the gas diffusion layers by coating the electrocatalyst and the dispersed particles of a polymeric binder in a suitable liquid medium onto the gas diffusion layer, e.g., carbon fiber paper. The carbon fiber paper with the electrodes attached and a membrane are then assembled into an MEA by pressing such that the electrodes are in contact with the membrane. In MEAs of this type, it is difficult to establish the desired ionic contact between the electrode and the membrane due to the lack of intimate contact. As a result, the interfacial resistance may be higher than desired. In the other main approach for forming electrodes, electrodes are formed directly onto the surface of the membrane. A membrane having electrodes so formed is often referred to as a CCM. Employing CCMs can provide improved performance over forming electrodes on the gas diffusion layer due to more intimate contact between the electrodes and the ionomeric polymer membrane. However, CCMs are typically difficult to manufacture.

Various manufacturing methods have been developed for manufacturing CCMs. Many of these processes have employed methods of coating electrocatalyst slurries containing the electrocatalyst and the ion exchange polymer and, optionally, other materials such as a PTFE dispersion, onto the ionomeric polymer membrane. The ion exchange polymer in the membrane itself, and the electrocatalyst coating solution could be employed in either the hydrolyzed or unhydrolyzed ion-exchange polymer (sulfonyl fluoride form when perfluorinated sulfonic acid polymer is used), and in the latter case, the polymer must be hydrolyzed during the manufacturing process. Techniques that use unhydrolyzed polymer in the membrane, the electrocatalyst composition or both can produce excellent CCMs but are difficult to apply to commercial manufacture because a hydrolysis step and subsequent washing steps are required after application of the electrode.

In some techniques, the catalyst is coated on a substrate as a slurry by a rolling process to form what's referred to as a “decal”. The catalyst is then transferred to the membrane by a hot pressing step. After the catalyst is coated onto the decal, an ionomer layer is sometimes sprayed over the catalyst layer before it is transferred to the membrane. Both the catalyst and the membrane include the ionomer, and the ionomer spray layer provides a better contact between the catalyst and the membrane and it decreases the contact resistance between the catalyst and the membrane. This increases the proton exchange between the membrane and the catalyst, and thus, increases fuel cell performance.

Use of different materials to serve as the substrates for making electrode decals, such as porous expanded polytetrafluoroethylene (ePTFE) as well as non-porous ethylene tetrafluoroethylene (eTFE) results in incomplete transfer of the electrodes to the ionomeric polymer membrane. MEAs prepared by the above described decal transfer methods have exhibited failure along the catalyst edge. Particularly, the membrane has been shown to tear adjacent to the outer edge of the catalyst layers on both the anode and cathode sides of the MEA. This failure typically corresponds to the edge of the decal substrate during the hot-pressing step. Because the decal substrates are smaller in area than the membranes and have a thickness of about 50-75 μm (2-3 mil), the decal substrate or active area section of the membrane would experience higher pressures than the remaining bare membrane areas during the hot-pressing step. This translates to a possible weakening of the membrane along the catalyst edges.

Additionally, with these decal methods of making CCMs, the goal is to achieve good distribution and movement through the electrodes of the fuel and oxidant. Further prevention of flooding the pores of the CCMs is also desired for proper function of the fuel cell. To achieve this goal, it is important to have an electrode with a relatively homogenous porous structure and which has good structural integrity, as such, the present invention is directed to the fabrication of the membrane electrode assembly with a process that significantly reduces excessive “mud-cracking” of the electrodes during the drying stage. Mud-cracking is where significant fissures of the surface of the electrode are created as the electrode film is formed during the drying process. Most catalyst layers will exhibit some degree of “mud-cracking”, however, excessive “mud-cracking” is visible to the naked eye and usually results in delamination from the support during drying. Often the transfer of the electrocatalyst to the membrane is incomplete resulting in residual electrocatalyst remaining behind on the backing film/substrate.

Methods that involve the transfer of decals onto the membranes usually involve a batch lamination process that needs improvement. The process of heating and compression allows for the transfer of both electrocatalyst layers onto the ionomeric polymer membrane, and release from their supported substrates. Lamination processes lend themselves to low productivity and higher unit cost of CCMs and improvements are desired. Particularly desired are the improvement of the quality of the electrocatalyst layers that are transferred, elimination of partial transfer of the electrodes, and prevention of cracking of the electrodes.

Accordingly, a process is needed which is suitable for the high volume production of CCMs and which avoids problems associated with prior art processes. Further, a process is needed which is suitable for the direct application of an electrocatalyst coating composition to a membrane in hydrolyzed form. Such a process avoids the swelling problems associated with known processes; does not require complicated pre-treatment or post-treatment process steps; and which allows for high quality, complete transfer of the electrodes to the ionomeric polymer membrane. Another advantage of such a process is the facilitation of high volume production of MEAs with reduced costs.

### SUMMARY

Disclosed herein is a process for manufacturing catalyst coated membranes. In one embodiment of the invention, the process for manufacturing a CCM is provided, comprising:
(a) providing a layered sandwich comprising:
   (i) an ionomeric polymer membrane having opposite first and second surfaces,
   (ii) a first electrocatalyst layer having a first surface adhered to a first flexible substrate and a second surface abutting the first surface of the ionomeric polymer membrane, and
   (iii) a second electrocatalyst layer having a first surface adhered to a second flexible substrate and a second surface abutting the second surface of the ionomeric polymer membrane;
(b) placing the layered sandwich of step (a) between two synchronously-driven, resilient, thermally conductive belts;
(c) feeding the two synchronously driven resilient, thermally conductive belts and the layered sandwich into, in sequence:
   (i) a pre-heating zone that heats the layered sandwich to a temperature of at least about 90° C. for at least about 4 minutes,
   (ii) a pair of nip rollers having a resilient coating on at least one roller, which applies an average pressure of at least about 6 MPa to the layered sandwich,
   (iii) a heating zone that heats the layered sandwich to a temperature of at least about 150° C. for at least about 1 minute,
   (iv) a pair of nip rollers having a resilient coating on at least one roller, which applies an average pressure of at least about 8 MPa to the layered sandwich, and
   (v) a cooling zone at a temperature of at least 25° C. for at least 1 minute;
(d) transferring completely the first electrocatalyst layer adhered to a first flexible substrate to the first surface of the ionomeric polymer membrane and the second electrocatalyst layer adhered to a second flexible substrate to the second surface of the ionomeric polymer membrane; and
(e) forming the catalyst coated membrane.

Upon exiting the lamination machine, the flexible substrates are removed by peeling and these CCMs have greater than 99.5% transfer of the electrocatalyst ink onto the ionomeric polymer membrane, and have no defects such as cracking/mud cracking. In an embodiment 100% transfer is obtained.

### BRIEF DESCRIPTION OF THE DRAWINGS

FIG. 1 shows a schematic of the layered sandwich.

FIG. 2 shows a schematic diagram of the lamination machine.

### DETAILED DESCRIPTION

### Definitions

As used herein “fuel cells” are electrochemical cells that convert reactants, namely fuel and oxidant fluid streams, to generate electric power and reaction products. A broad range of reactants can be used in fuel cells and such reactants may be delivered in gaseous or liquid streams. For example, the fuel stream may be substantially pure hydrogen gas, a gaseous hydrogen-containing reformate stream, or an aqueous alcohol, for example, methanol, in a direct methanol fuel cell (DMFC). The oxidant may, for example, be substantially pure oxygen or a dilute oxygen stream such as air.

As used herein in SPE fuel cells, the solid polymer electrolyte membrane is typically perfluorinated sulfonic acid polymer membrane in acid or fluoride form. Such fuel cells are often referred to as proton exchange membrane (PEM) fuel cells. The membrane is disposed between, and in contact with, the anode and the cathode. Electrocatalysts in the anode and the cathode typically induce the desired electrochemical reactions and may be, for example, a metal black, or an alloy or a metal catalyst supported on a substrate, e.g., platinum on carbon.

As used herein the ionomeric polymer membrane is comprised of an ion exchange polymer, also known as an ionomer.

As used herein “flooding” generally refers to a situation where the pores in an electrode become filled with water formed as a reaction product, such that the flow of the gaseous reactant through the electrode becomes impeded. In electrodes for some fuel cells employing gaseous feed fuels, hydrophobic components such as polytetrafluoroethylene (PTFE) are typically employed, in part, to render electrodes less wettable and to prevent flooding.

As used herein, the term “dispersion” refers to a composition of polymer particles within a liquid medium.

As used herein “chemically stabilized” means that that the fluorinated copolymer was treated with a fluorinating agent to reduce the number of unstable groups in the copolymer. Chemically stabilized polymers are described in GB 1,210,794. The —SO₂F groups of the copolymer had been hydrolyzed and acid exchanged to the —SO₃H form.

As used herein in a batch lamination process a multi-layered sandwich arranged in order as follows: an aluminium sheet (⅛″ or 3.18 mm thick), a silicone rubber sheet (⅛″ or 3.18 mm thick), a stainless steel sheet ( 1/16: or 1.59 mm thick), a decal containing the anode electrocatalyst, the polymer membrane (positioned at the center of the sandwich), a decal containing the cathode electrocatalyst, a stainless steel sheet ( 1/16″ or 1.59 mm thick)), a silicone rubber sheet (⅛″ or 3.18 mm thick), and an aluminum sheet (⅛″ or 3.18 mm thick). The multi-layered sandwich assembly is placed in a hydraulic press and laminated. The lamination process takes about 20 minutes; about 5 minutes heat-cured at 150° C. and 80,000 kgs of ram force, followed by 15 minutes of cooling at 30° C. The sandwich then exits the lamination machine and the temporary decal substrates are peeled off the final product.

Disclosed herein is a method for manufacturing CCMs using a lamination process comprising feeding a layered sandwich of an ionomeric polymer membrane, positioned between a decal containing an anode electrocatalyst and a decal containing a cathode electrocatalyst simultaneously between a pair of nip rollers on a lamination machine. The electrocatalyst layer may be provided in the form of a decal which could be made, for example, by flexographic printing or by direct coating of an electrocatalyst ink onto a dimensionally stable, temporary substrate. Decals may also be made by screen printing, stencil printing or other alternative methods known in the art. The lamination process employs the use of two synchronously-driven, resilient, thermally conductive belts that are used as conveyor belts.

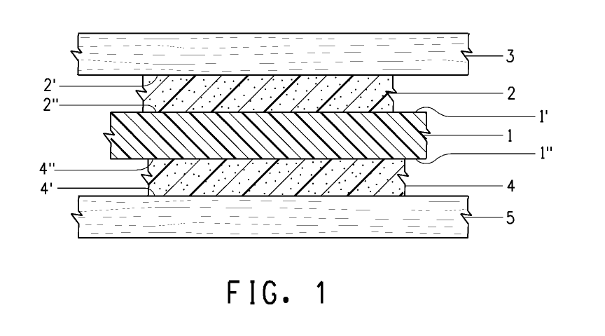

A schematic diagram of the layered sandwich according to an embodiment is shown generally in FIG. 1. The ionomeric polymer membrane (1) has opposite first and second surfaces shown as (1′) and (1″) respectively. The first electrocatalyst layer (2) with the first surface 2′ adhered to a first flexible substrate (3). The second surface (2″) abuts the first surface of the ionomeric polymer membrane (1′). The second electrocatalyst layer (4) has a first surface (4′) adhered to a second flexible substrate (5) and the second surface (4″) abutting the second surface of the ionomeric polymer membrane (1″).

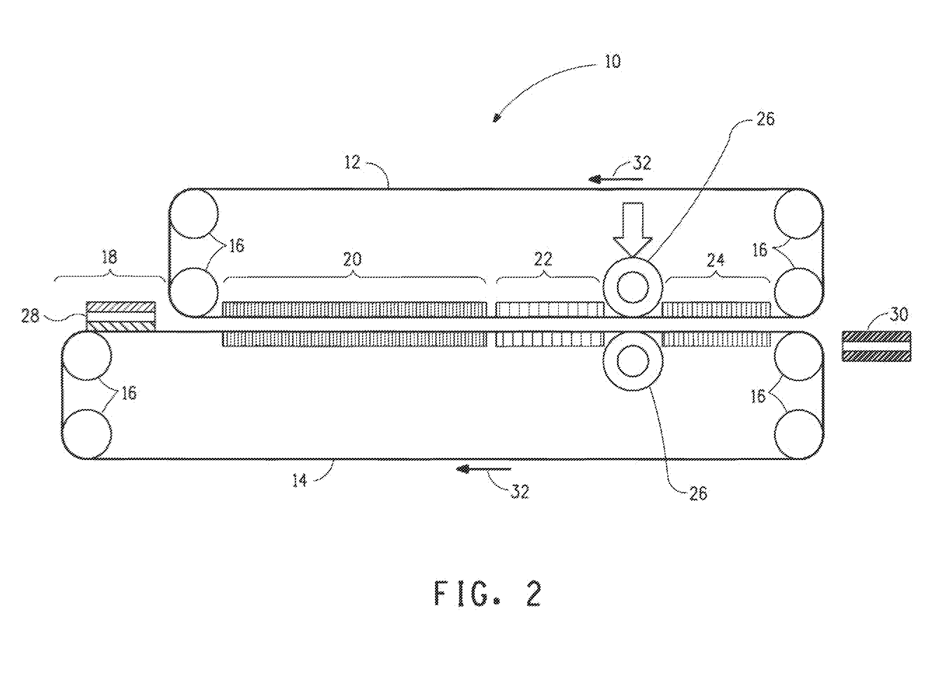

A schematic diagram of the lamination machine (10) to prepare the layered sandwich (28) is shown in FIG. 2. The lamination machine includes two conveyor belts, an upper belt (12) and a lower belt (14). Both the lower belt and the upper belt are driven by drive rolls (16). The layered sandwich having a first electrocatalyst layer, the ionomeric polymer membrane and the second electrocatalyst layer is placed is placed on the extended loading area (18) on the lower belt (14). The layered sandwich moves in the direction of the conveyor belts (32) and travels between the upper and lower belts through the lamination machine. The layered sandwich first moves through a pre-heating zone (20) and then through a heating zone (22) and followed by a cooling zone (24). A pair of 8″ nip rollers (26) that is coated with silicone rubber is placed between the heating zone and the cooling zone. After exiting the lamination machine the layered sandwich exits the lamination machine as a CCM (30). Complete transfer of the electrocatalyst from the decals to the ionomeric polymer membrane is achieved. The CCMs produced using this method have no defects such as cracking/mud cracking.

In an embodiment two nip rollers are used to apply pressure on the layered sandwich. These two nips work together at different pressures, the first nip operating at least 6 MPa of pressure and the second nip applying at least 8 MPa. It is suitable that all the nip rollers to have the same outside diameter. The material for the nip rollers can be can be metal, solid rubber, solid high density plastic and rubber coated on metal among others. The nip rollers can be a combination of two materials such as (i) metal & solid rubber, (ii) metal & solid high density plastic, (iii) metal & rubber coated on metal, (iv) solid rubber & solid high density plastic, (v) rubber coated on metal & solid rubber, and (vi) rubber coated on metal & solid heavy plastic. It is preferred that silicone rubber that covers the rollers has a durometer shore hardness of at least 65.

In an embodiment, the conveyer belts are comprised of resilient, thermally conductive continuous belts. Each of the resilient, thermally conductive continuous belts are comprised of a first layer of silicone rubber between about 1 and 2 mm in thickness and having a durometer shore hardness of at least 55; a core reinforcement polyester fabric layer between about 0.5 and 1.5 mm thick, and a second thin layer between about 0.05 and 0.5 mm thick and having a durometer shore hardness of at least 55. The first thick layer of silicone is the top layer of the belt, onto which the layered sandwich made from the first electrocatalyst decal, the ionomer membrane and the second electrocatalyst decal, is placed. Further, the conveyor belt is made as one continuous belt, and not from tow or more pieces spliced together. This allows for an improved lamination process. The temperatures to which the conveyor belts can be operated is between −73° C. (−100° F.) to 204° C. (400° F.).

The use of these materials as the conveyor belts in the lamination machine, along with the continuous nature of the belt, in addition to operating at the appropriate temperatures and pressures, allows for complete (typically 99.5 to 100%) transfer of the electrocatalyst layers onto the ionomeric polymer membrane.

### Ionomeric Polymer Membranes

The ionomeric polymer membrane is comprised of an ion exchange polymer, also known as an ionomer. A suitable ionomer has cation exchange groups that can transport protons across the membrane. The cation exchange groups are acids that can be selected from the group consisting of sulfonic, carboxylic, boronic, phosphonic, imide, methide, sulfonimide and sulfonamide groups. Typically, the ionomer has sulfonic acid and/or carboxylic acid groups. Various known cation exchange ionomers can be used including ionomeric derivatives of trifluoroethylene, tetrafluoroethylene, styrene-divinylbenzene, alpha, beta, beta-trifluorostyrene, etc., in which cation exchange groups have been introduced.

Ionomeric polymer membranes are preferably highly fluorinated ion-exchange polymers. However, other ionomers may be utilized in the proton exchange membrane such as partially fluorinated ionomers including ionomers based on trifluorostyrene, ionomers using sulfonated aromatic groups in the backbone, non-fluorinated ionomers including sulfonated styrenes grafted or copolymerized to hydrocarbon backbones, and polyaromatic hydrocarbon polymers possessing different degrees of sulfonated aromatic rings to achieve desired range of proton conductivity in the membrane. “Highly fluorinated” means that at least 90% of the total number of univalent atoms in the polymer are fluorine atoms. Most typically, the polymer is perfluorinated. It is typical for polymers used in fuel cell membranes to have sulfonate ion exchange groups. The term “sulfonate ion exchange groups” as used herein refers to either sulfonic acid groups or salts of sulfonic acid groups, typically alkali metal or ammonium salts. For applications where the ionomeric polymer is to be used for proton exchange as in fuel cells, the sulfonic acid form of the polymer is preferred. If the polymer in the electrocatalyst coating composition is not in sulfonic acid form when used, a post treatment acid exchange step will be required to convert the polymer to acid form prior to use. Suitable perfluorinated sulfonic acid polymer membranes in acid form are available from E.I. du Pont de Nemours and Company, Wilmington, Del., under the trademark Nafion®.

The ion-exchange polymer used to make the ionomeric polymer membrane comprises a polymer backbone with recurring side chains attached to the backbone with the side chains carrying the ion-exchange groups. Possible polymers include homopolymers or copolymers of two or more monomers, or blends thereof. Copolymers are typically formed from one monomer which is a nonfunctional monomer and which provides carbon atoms for the polymer backbone, and a second monomer that provides both carbon atoms for the polymer backbone and also contributes a side chain carrying the cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidene fluoride, trifluoroethylene, chlorotrifluoroethylene, perfluoro(alkyl vinyl ether), and mixtures thereof. Possible second monomers include a variety of fluorinated vinyl ethers with sulfonate ion exchange groups or precursor groups which can provide the desired side chain in the polymer. The first monomer may also have a side chain which does not interfere with the ion exchange function of the sulfonate ion exchange group. Additional monomers can also be incorporated into these polymers if desired. The sulfonic acid form of the polymer may be utilized to avoid post treatment acid exchange steps.

Typical polymers for use as ionomeric polymer membranes include a highly fluorinated, most typically a perfluorinated, carbon backbone with a side chain represented by the formula —(O—CF₂CFRf)ₐ—(O—CF₂)_{b}—(CFR′f)_{c}SO₃M, wherein R_{f} and R′_{f} are independently selected from F, Cl or a perfluorinated alkyl group having 1 to 10 carbon atoms, a=0, 1 or 2, b=0-1, and c=0 to 6, and m is hydrogen, Li, Na, K or N(R₁)(R₂)(R₃)(R₄) and R₁, R₂, R₃, and R₄ are the same or different and are H, CH₃ or C₂H₅. Specific examples of suitable polymers include those disclosed in U.S. Pat. Nos. 3,282,875; 4,358,545; and 4,940,525. One exemplary polymer comprises a perfluorocarbon backbone and a side chain represented by the formula —O—CF₂CF(CF₃)—O—CF₂CF₂SO₃H. Such polymers are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid, also known as the proton form.

Another ion-exchange polymer of the type disclosed in U.S. Pat. Nos. 4,358,545 and 4,940,525 has a side chain —O—CF₂CF₂SO₃H. The polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange.

For perfluorinated polymers of the type described above, the ion exchange capacity of a polymer can be expressed in terms of ion exchange ratio (IXR). Ion exchange ratio is defined as number of carbon atoms in the polymer backbone in relation to the number of ion exchange groups. A wide range of IXR values for the polymer are possible. Typically, however, the IXR range for perfluorinated sulfonate polymer is about 7 to about 33. For perfluorinated polymers of the type described above, the cation exchange capacity of a polymer can be expressed in terms of equivalent weight (EW). Equivalent weight (EW), as used herein, is the weight of the polymer in acid form required to neutralize one mole equivalent of NaOH. For a sulfonate polymer having a perfluorocarbon backbone and a side chain —O—CF₂—CF(CF₃)—O—CF₂—CF₂—SO₃H (or a salt thereof), the equivalent weight range corresponding to an IXR of about 7 to about 33 is about 700 EW to about 2000 EW. A preferred range for IXR for such a polymer is from about 8 to about 23 (750 to 1500 EW), and a more preferred range is from about 9 to about 15 (800 to 1100 EW).

Ionomeric polymer membranes can be made from highly fluorinated ion exchange polymer described above using known extrusion techniques or can be made from dispersions of the highly fluorinated ion exchange polymers described above, by known casting techniques. These membranes have thicknesses that can vary depending upon the intended application, typically ranging from 10 mils (about 254 microns) to less than 1 mil (about 25.4 microns). The preferred membranes used in fuel cell applications have thicknesses of about 5 mils (about 127 microns) for direct methanol fuel cells (DMFC) applications, and preferably thicknesses of about 2 mils (about 50.8 microns) or less for hydrogen fuel cells (H₂FC) applications. Extruded membranes and dispersions of these highly fluorinated ion exchange polymers are available from E.I. du Pont de Nemours and Company under the trademark Nafion®.

Ionomeric polymer membranes may also have incorporated within the membranes, or on their surfaces, catalytically active particles added to improve the durability of these membranes. These particles may be incorporated by imbibing into an extruded membrane, may be added to dispersions of the polymers and then cast, or may be coated onto the surface of the polymer membranes.

Reinforced perfluorinated ion exchange polymer membranes can also be made from the highly fluorinated ion exchange polymer described above using known casting techniques. Reinforced membranes can be made by impregnating a porous substrate with a dispersion of ion exchange polymer in an organic liquid and/or water. The porous substrate may improve mechanical properties for some applications and/or decrease costs. The porous substrate can be made from a wide range of components, including, for example, hydrocarbons, polyolefins such polyethylene, polypropylene, polybutylene, and copolymers including polyolefins. Perhalogenated polymers such as polytetrafluoroethylene (PTFE) or polychlorotrifluoroethylene can also be used. Impregnation of expanded PTFE (ePTFE) with perfluorinated sulfonic acid polymer is disclosed in U.S. Pat. Nos. 5,547,551 and 6,110,333. These types of reinforcements may also be used in making the ionomeric polymer membranes. ePTFE is available under the trade name “Goretex” from W. L. Gore and Associates, Inc., Elkton, Md., and under the trade name “Tetratex” from Tetratec, Feasterville, Pa. Alternatively, the porous substrate may be comprised of perfluoroalkoxy (PFA), fluorinated ethylene propylene (FEP), polyvinylidene fluoride (PVDF), ethylene/tetrafluoroethylene copolymer (ETFE), and ethylene/chlorotrifluorethylene copolymer (ECTFE), and combinations thereof. Porous substrates that comprise aramid fibers of Kevlar® fibrils or Nomex® fibrils available from E.I. du Pont de Nemours and Company, Wilmington, Del., can also be used.

### Electrocatalyst Coating Composition

The electrocatalyst inks or pastes for use in making the anode electrodes or the cathode electrodes is made by combining the electrocatalyst, a highly fluorinated ion-exchange polymer (binder), and a suitable liquid medium. The electrodes can be coated onto the temporary substrate, to form “decals”. Several methods, such as flexographic printing or direct printing of an electrocatalyst ink or paste onto a temporary substrate, can be used to make these decals.

Electrocatalysts in the composition are selected based on the particular intended application for the catalyst coated membrane (CCM). Electrocatalysts suitable for use in the present invention include one or more noble group metals such as platinum, ruthenium, rhodium, and iridium and electroconductive oxides thereof, and electroconductive reduced oxides thereof. The catalyst may be supported or unsupported. Typically used electrocatalyst compositions for hydrogen fuel cells are platinum metal supported on carbon, for example, 60 wt % carbon, 40 wt % platinum such as the material with this composition obtainable from E-Tek Corporation Natick, Mass., and 60% platinum, 40% carbon obtainable from Johnson-Matthey as FC-60. For direct methanol fuel cells, electrocatalyst composition for the anode electrode is different from that for the cathode electrode. In general, the noble metal used for the cathode electrode is platinum, and/or platinum with cobalt. (Pt—Ru)Oₓ electrocatalyst has been found to be useful in the anode electrode.

The ion exchange polymer may perform several functions in the resulting electrode including serving as a binder for the electrocatalyst and improving ionic conductivity to catalytic sites. The ion exchange polymer employed in the electrocatalyst coating composition serves not only as binder for the electrocatalyst particles but may also assist in securing the electrode to the ionomeric polymer membrane. It is typical, therefore, for the ion exchange polymers in the electrocatalyst coating composition to be compatible with the ion exchange polymer in the membrane. Ion-exchange polymers suitable for use as a binder in the anode and cathode electrodes of this invention are the highly fluorinated ion-exchange polymers discussed above for use in making the ionomeric polymer membrane. The ion-exchange polymers typically have end groups in sulfonyl halide form, but may alternatively have end groups in the sulfonic acid form.

The liquid medium for the catalyst coating composition is one selected to be compatible with the process. It is advantageous for the medium to have a sufficiently low boiling point that rapid drying of electrode layers is possible under the process conditions employed, provided however, that the composition does not dry so fast that the composition dries before transfer to the temporary substrate. When flammable constituents are to be employed, the medium can be selected to minimize process risks associated with such constituents, as the medium is in contact with the electrocatalyst during use. The medium should also be sufficiently stable in the presence of the ion-exchange polymer that, in the acid form, has strong acidic activity. The liquid medium is typically polar for compatibility with the ion-exchange polymer, and is preferably able to wet the proton exchange membrane. Preferably, the ion-exchange polymer coalesces upon drying of the liquid medium and the polymer does not require post treatment steps such as heating to form a stable electrode layer. Where the liquid medium is water, it may be used in combination with surfactant, alcohols or other miscible solvents.

A wide variety of polar organic liquids and mixtures thereof can serve as suitable liquid medium for the electrocatalyst coating ink or paste. Water can be present in the medium if it does not interfere with the coating process. Although some polar organic liquids can swell the membrane when present in sufficiently large quantity, the amount of liquid used in the electrocatalyst coating is preferably small enough that the adverse effects from swelling during the process are minor or undetectable. It is believed that solvents able to swell the ion-exchange membrane can provide better contact and more secure application of the electrode to the membrane. A variety of alcohols are well suited for use as the liquid medium.

Typical liquid mediums include suitable C₄ to C₈ alkyl alcohols such as n-, iso-, sec- and tert-butyl alcohols; the isomeric 5-carbon alcohols such as 1,2- and 3-pentanol, 2-methyl-1-butanol, 3-methyl, 1-butanol; the isomeric 6-carbon alcohols, such as 1-, 2-, and 3-hexanol, 2-methyl-1-pentanol, 3-methyl-1-pentanol, 2-methyl-1-pentanol, 3-methyl, 1-pentanol, 4-methyl-1-pentanol; the isomeric C₇ alcohols and the isomeric C₈ alcohols. Cyclic alcohols are also suitable. Preferred alcohols are n-butanol and n-hexanol, and n-hexanol is more preferred. Other preferred liquid mediums are fluorinated solvents such as the primarily 12 carbon perfluoro compounds of FC-40 and FC-70 Fluorinert™ brand electronic liquids from 3M Company. The amount of liquid medium used in the electrocatalyst coating ink or paste varies and is determined by the type of medium employed, the constituents of the electrocatalyst coating, the type of coating equipment employed, the desired electrode thickness, the process speeds, and other process conditions.

Optionally, other components can be included in the composition, e.g., polytetrafluoroethylene (PTFE) in dispersion form, or an amorphous fluoropolymer such as a copolymer of tetrafluoroethylene and 2,2-bistrifluoromethyl 4,5-difluoro-1,3-dioxole (PDD) which has been found to be useful when the electrocatalysts are of the platinum/cobalt The copolymers of TFE and PDD are available as Teflon® AF 1600 from E.I. duPont de Nemours and Company.

The size of the particles in the electrocatalyst ink is reduced by grinding, milling or sonication to obtain a particle size that results in the best utilization of the electrocatalyst. The particle size, as measured by a Hegman gauge, is preferably reduced to less than 10 microns and more preferably to less than 5 microns.

### Flexible Substrates:

The electrocatalyst ink is coated onto a flexible substrate to form an electrode decal. These flexible substrates are temporary since in the process of feeding the layered sandwich through the laminator, the electrodes transfer completely, and bind onto the ionomeric polymer membrane. The flexible substrate is peeled away after the layered sandwich goes through the lamination machine. This flexible substrate serves as temporary support may be of any material that has dimensional stability during the processing steps of the invention. The flexible substrate may have a release surface or be provided with a release surface by treating or coating it with a substance that would assist in its removal. Some suitable examples of flexible substrates serves as temporary support include polyesters including polyethylene terephthalate, polyethylene naphthanate; polyamides, polycarbonates, fluoropolymers, polyacetals, polyolefins, etc. Some examples of polyester films include Mylar® or Melinex® polyester films, E.I. duPont de Nemours and Company, Wilmington, Del. Some temporary supports having high temperature stability include polyimide films such as Kapton®, available from E.I. duPont de Nemours and Company, Wilmington, Del.

### Electrode Decals:

Electrocatalyst inks may be coated onto a flexible substrate to produce electrode decals for incorporation into a catalyst coated membrane (CCM). Known electrocatalyst coating techniques can be used and produce a wide variety of applied layers of essentially any thickness ranging from very thick, e.g., 30 μm or more, to very thin, e.g., 1 μm or less. Typical manufacturing techniques involve the application of the electrocatalyst ink onto a flexible substrate to form a decal. Methods for applying the electrocatalyst onto the flexible substrate include spraying, painting, patch coating and screen printing or flexographic printing. The thickness of the anode and cathode electrodes typically ranges from about 0.1 to about 30 microns.

The applied layer thickness electrocatalyst is dependent upon compositional factors as well as the process used to generate the layer. The compositional factors include the metal loading on the coated substrate, the void fraction (porosity) of the layer, the amount of polymer/ionomer used, the density of the polymer/ionomer, and the density of the carbon support. The process used to generate the layer (e.g. a hot pressing process versus a painted on coating or drying conditions) can affect the porosity and thus the thickness of the layer.

### EXAMPLES

This lamination process may be used for manufacturing CCMs that may be used not only in direct methanol fuel cells, but also in hydrogen and reformate fuel cells. The following specific examples are intended to illustrate the practice of the invention and should not be considered to be limiting in any way. The following electrodes were prepared and tested as described hereinbelow.

### Ionomeric Polymer Membrane:

Both extruded and cast membranes were used in this invention. The extruded membranes were 5 mil thick, and are available commercially as Nafion® N-115 from E.I. duPont de Nemours, Wilmington, Del. Nafion® DE-2021 polymer dispersions were used to cast membranes with thicknesses of 3.4 mil and 5.0 mil. These dispersions were produced by charging a mixture of TFE/PDMOF copolymer pellets (25+/−2 wt %), ethanol (15+/−2 wt %) and deionized water (60+/−2 wt %) into an agitated/baffled/hot oil jacketed pressure reactor vessel. The TFE/PMDOF copolymer had an EW of 1000, and had been chemically stabilized.

Cast membranes were made with the casting process using a coater that was configured to prevent runback during the casting of these thick membranes. The extruded membranes were submerged in deionized water for 60 minutes at 80° C., then taken out and submerged in deionized water at room temperature to relax for about 10 minutes.

### Cathode:

A cathode electrode decal was prepared by drawing down cathode catalyst ink to a dimension of 5 cm×5 cm (to give a total area of 25 cm²) on a 10 cm×10 cm piece of 3 mil thick Kapton® polyimide film (obtained from E.I. DuPont de Nemours and Company, Wilmington, Del.). A Pt loading of 2.1 mg Pt/cm² was achieved by knife drawdown coating with this ink. The dry coating thickness was about 0.5 mil.

Cathode catalyst ink was prepared as follows. 85.93 g of Nafion® 920 EW dispersion, in the proton form (Nafion® D-2020, 22.13% solids available from E.I. duPont de Nemours and Company, Wilmington, Del.) were added to a beaker which was immersed in an ice bath. The beaker was in a nitrogen-purged box in a hood. 144 g of isopropanol and 106.4 g of n-propanol were then added to the beaker with stirring. The solution was stirred for 30-45 min under a nitrogen atmosphere, and cooled to about 5° C., using an ice bath. 66.5 g of carbon-supported Pt catalyst (67 wt % Pt, 33 wt % particulate carbon) with a BET surface area of 240 m²/g (TEC10E70TPM catalyst obtained from Tanaka Kikinzoku Kogyo KK, Kanagawa, Japan) was then added slowly to the dispersion over a period of 5-7 minutes under a nitrogen atmosphere, while stirring the solution with high shear mixing. The temperature of the solution was maintained at below 10° C. Stirring of the contents of the flask was maintained for 10-15 min under the nitrogen atmosphere in the ice bath. The mixture was cooled to 5° C. while stirring. Upon reaching 5° C., the mixture was sonicated for between 3-9 minutes. The mixture was kept at between 5 to 15° C. during sonication. The sonication was stopped, as necessary, to allow the mixture to cool. Samples of the catalyst ink so formed were taken at various time intervals and analyzed for particle size and viscosity. The particle size in this electrocatalyst ink was measured using a Beckman Coulter LS Particle Size Analyzer. The D₅₀ of the final electrocatalyst ink was 3.2 microns. 35.3 g of diprolylene glycol monomethyl ether (Dowanol™ DPM) solvent were added and the dispersion was agitated for 1 minute followed by 10 minutes of equilibriation.

### Anode:

A anode electrode decal was prepared by drawing down the anode catalyst ink to a dimension of 5 cm×5 cm (to give a total area of 25 cm²) on a 10 cm×10 cm piece of 3 mil thick Kapton® polyimide film (obtained from E.I. DuPont de Nemours and Company, Wilmington, Del.). A Pt/Ru loading of between 2.2 and 2.5 mg Pt/cm² was achieved by knife drawdown coating with this ink. The dry coating thickness was about 0.5 mil.

Cathode catalyst ink was prepared as follows.100.2 g of Nafion® 920 EW dispersion (in the proton form) (Nafion® D-2020, 22.13% solids available from E.I. duPont de Nemours and Company, Wilmington, Del.) were added to a beaker which was immersed in an ice bath. The beaker was in a nitrogen-purged box in a hood. 20.05 g of isopropanol and 20.05 g of n-propanol were then added to the flask with stirring. The solution was stirred for 30-45 min under a nitrogen atmosphere, and cooled to about 5° C., using an ice bath. Half of the 44.3 g of carbon supported Pt/Ru catalyst (50 wt % Pt, 25 wt % Ru and 25 wt % particulate carbon) with a BET surface area of 150-90 m²/g (TEC86E86 catalyst obtained from Tanaka Kikinzoku Kogyo KK, Kanagawa, Japan) was then added slowly to the dispersion over a period of 5-7 minutes under a nitrogen atmosphere, while stirring the solution with high shear mixing. The mixture was stirred for about 10 min or until the second exotherm occurred. The mixture was then cooled to about 5° C. and the remaining catalyst was added. After its final exotherm, the mixture was cooled to about 5° C. under the nitrogen atmosphere in the ice bath. The dispersion was held overning in the nitrogen-purged box without stirring. After sitting overnight, the mixture was sonicated for 9 minutes. The mixture was kept at 5-15° C. during sonication, and sonication was stopped, as necessary, in order to cool the mixture. Samples of the catalyst ink so formed were taken at various time intervals and analyzed for particle size and viscosity. The particle size in this electrocatalyst ink was measured using a Beckman Coulter LS Particle Size Analyzer. The D₅₀ of the final electrocatalyst ink was 1.25 microns. 13.2 g of diprolylene glycol monomethyl ether (Dowanol™ DPM) solvent were added and the dispersion was agitated for 1 minute followed by 10 minutes of equilibration.

### Membrane Electrode Assembly:

For all examples, either cast or extruded membranes of varying thicknesses (3.4 mil or 5 mil) were sandwiched between one of the anode electrode decal described above wherein the anode electrocatalyst layer faced one surface of the extruded membrane, and one of the cathode electrode decal described above wherein the cathode electrocatalyst layer layer faced the opposite surface of the extruded membrane. Care was taken to ensure that the coatings on the two decals were registered with each other and were positioned facing the membrane. The entire assembly was fed into the lamination machine at a linespeed of 0.75 ft/min and with a nip roll pressure of 1295 psi (8.9 Mpa). The temperature of the pre-heating zone was set to 93° C., and the temperature of the heating/curing zone was set to 160° C. The temperature of the cooling section was set to an inlet temperature and outlet temperature of 20±2° C.

Upon exiting the lamination machine, the layered sandwiched was removed. The flexible substrates from both the anode and the cathode decals were carefully removed to obtain the CCM. 100% transfer of both the cathode and the anode electrodes onto the membrane were observed.

These CCMs were tested for cell performance in a DMFC test cell. CCM performance measurements were made employing a single cell test assembly obtained from Fuel Cells Technologies, Inc., New Mexico. Membrane electrode assemblies were made that comprised one of the above CCMs sandwiched between two sheets of the gas diffusion backing (GDB), taking care to ensure that the GDB covered the electrode areas on the CCM. The anode gas diffusion backing comprised of an 8 mil thick carbon paper coated with a 1.7 mil thick microporous carbon powder coating. The cathode gas diffusion backing comprised of an 8 mil thick nonwoven carbon fabric with a PTFE coating (FCX0026 from Freudenberg). The microporous layer on the anode side GDB was disposed towards the anode catalyst. Two 7 mil thick glass fiber reinforced silicone rubber gaskets (Furan—Type 1007, obtained from Stockwell Rubber Company) each along with a 1 mil thick FEP polymer spacer were cut to shape and positioned so as to surround the electrodes and GDBs on the opposite sides of the membrane and to cover the exposed edge areas of each side of the membrane. Care was taken to avoid overlapping of the GDB with the gasket material. The entire sandwich assembly was assembled between the anode and cathode flow field graphite plates of a 25 cm² standard single cell assembly (obtained from Fuel Cell Technologies, Inc., Los Alamos, N. Mex.). The test assembly was also equipped with an anode inlet, an anode outlet, a cathode gas inlet, a cathode gas outlet, aluminium end blocks, tied together with tie rods electrically insulating layer and the gold plated current collectors. The bolts on the outer plates of the single cell assembly were tightened with a torque wrench to a force of 2 ft.lbs.

The single cell assembly was then connected to the fuel cell test station. The components in a test station include a supply of air for use as the cathode gas, a load box to regulate the power output from the fuel cell, a methanol solution tank to hold the feed anolyte solution, a liquid pump to feed the anolyte solution to the fuel cell anode at the desired flow rate, a condenser to cool the anolyte exiting from the cell, from the cell temperature to room temperature, and a collection bottle to collect the spent anolyte solution.

With the cell at room temperature, 1 M methanol solution and air were introduced into the anode and cathode compartments through inlets of the cell at flow rates of 1 cm³/min and 90 cm³/min. The temperature of the single cell was slowly raised until it reached 70° C. The methanol and air feed rates were maintained proportional to the current while the resistance in the circuit was varied in steps so as to increase the current. The voltage at each current step was recorded in order to produce a current versus voltage plot for the cell. Using this plot, the current density, expressed in mW/cm², at a voltage of 400 mVolts was determined and is as tabulated hereinbelow.

Table 1 and Table 2 shows the results of cell testing of membrane electrode assemblies made using CCMs prepared. In Table 1, samples 1-4 were fed through a lamination process using the lamination nip configuration: 8″ silicone roller at the top of the silicone conveyor belt, and an 8″ stainless steel roller at the bottom of the same silicone conveyor belt. In Table 2, samples 5-10 were fed through a lamination process using the lamination nip configuration: 8″ silicone roller at the top of the silicone conveyor belt, and an 8″ silicone roller at the bottom of the same silicone conveyor belt.

TABLE 1
Cell Performance of MEAs prepared with CCMs

| | | Mean | | | Cell |
|---|---|---|---|---|---|
| | Anode | Cathode | Membrane | Cell | Performance |
| Sample | Loading | Loading | Type and | Resistance | 9A-PD@400 mV |
| No. | (mg/cm²) | (mg/cm²) | Thickness | (mohms) | (mW/cm²) |
| Sample 1 | 2.16 | 2.06 | Cast, 5.0 mil | 6.3 | 96.6 |
| Sample 2 | 2.25 | 2.00 | Cast, 5.0 mil | 6.4 | 91.3 |
| Sample 3 | 2.28 | 2.00 | Cast, 3.4 mil | 4.6 | 106.0 |
| Sample 4 | 2.81 | 2.00 | Cast, 3.4 mil | 6.3 | 93.0 |

TABLE 2
Cell Performance of MEAs prepared with CCMs

| | | | | | Cell |
|---|---|---|---|---|---|
| | Anode | Cathode | Membrane | Cell | Performance |
| Sample | Loading | Loading | Type and | Resistance | 9A-PD@400 mV |
| No. | (mg/cm²) | (mg/cm²) | Thickness | (mohms) | (mW/cm²) |
| Sample 5 | 2.50 | 2.33 | Extruded Wet N115 | 6.1 | 106.7 |
| Sample 6 | ~2.10 | 2.16 | Extruded Dry N115 | 6.7 | 89.4 |
| Sample 7 | 2.47 | 2.00 | Cast, 5.0 mil | 5.9 | 96.9 |
| Sample 8 | 2.44 | 2.02 | Cast, 5.0 mil | 5.2 | 103.8 |
| Sample 9 | 2.30 | 1.99 | Cast, 3.4 mil | 5.2 | 112.0 |
| Sample 10 | 2.34 | 2.04 | Cast, 3.4 mil | 5.6 | 107.6 |

A current density of 90.0 mW/cm² at a voltage of 400 mV is generally considered the minimum necessary for use in a direct methanol fuel cell. It can be seen in the examples, that this minimum level of performance is reached or surpassed by all MEAs produced using the lamination process described hereinabove.

What is claimed is:

1. A process for forming a catalyst coated membrane comprising:
(a) providing a layered sandwich comprising:
(i) an ionomeric polymer membrane having opposite first and second surfaces,
(ii) a first electrocatalyst layer having a first surface adhered to a first flexible substrate and a second surface abutting the first surface of the ionomeric polymer membrane, and
(iii) a second electrocatalyst layer having a first surface adhered to a second flexible substrate and a second surface abutting the second surface of the ionomeric polymer membrane;
(b) placing the layered sandwich of step (a) between two synchronously-driven, resilient, thermally conductive belts;
(c) feeding the two synchronously driven resilient, thermally conductive belts and the layered sandwich into, in sequence:
(i) a pre-heating zone that heats the layered sandwich to a temperature of at least about 90° C. for at least about 4 minutes,
(ii) a pair of nip rollers having a resilient coating on at least one roller, which applies an average pressure of at least about 6 MPa to the layered sandwich,
(iii) a heating zone that heats the layered sandwich to a temperature of at least about 150° C. for at least about 1 minute,
(iv) a pair of nip rollers having a resilient coating on at least one roller, which applies an average pressure of at least about 8 MPa to the layered sandwich, and
(v) a cooling zone at a temperature of at least 25° C. for at least 1 minute;
(d) transferring completely the first electrocatalyst layer adhered to a first flexible substrate to the first surface of the ionomeric polymer membrane and the second electrocatalyst layer adhered to a second flexible substrate to the second surface of the ionomeric polymer membrane; and
(e) forming the catalyst coated membrane.

2. The process of claim 1 wherein the resilient coating on the nip roller is silicone.

3. The process of claim 1 wherein the resilient, thermally conductive continuous belts operate at temperatures not exceeding 205° C.

4. The process of claim 1 wherein each of the resilient, thermally conductive continuous belts are comprised of a first layer of silicone rubber between about 1 and 2 mm in thickness and having a durometer shore hardness of at least 55; a core reinforcement polyester fabric layer between about 0.5 and 1.5 mm thick, and a second thin layer between about 0.05 and 0.5 mm thick and having a durometer shore hardness of at least 55.

5. The process of claim 1 wherein the ionomeric polymer membrane is a highly fluorinated ion exchange polymer.

6. The process of claim 5 wherein the highly fluorinated ion exchange polymer is a perfluorinated sulfonic acid ionomer.

7. The process of claim 1 wherein the first electrocatalyst layer is a cathode and the second electrocatalyst layer is an anode.

8. The process of claim 7 wherein the cathode comprises an electrocatalyst and a highly fluorinated ion-exchange polymer binder, and a metal supported on particulate carbon.

9. The process of claim 7 wherein the cathode comprises 50 to 90 wt % of an electrocatalyst and 50 to 10 wt % of a highly fluorinated ion-exchange polymer binder, said electrocatalyst being comprised of at least 50 wt % platinum and at least about 15 to 50 wt % particulate carbon wherein the platinum is supported on the particulate carbon and wherein the total loading of the metal in the cathode is less than 3 mg/cm2.

10. The process of claim 7 wherein the anode comprises an electrocatalyst and a highly fluorinated ion-exchange polymer binder, and a metal supported on particulate carbon.

11. The process of claim 7 wherein the anode comprises an electrocatalyst and a highly fluorinated ion-exchange polymer binder, said anode electrocatalyst being comprised of an anode metal supported on particulate carbon, wherein the anode metal is comprised of platinum and ruthenium.

12. The process of claim 10 wherein the anode comprises 50 to 90 wt % of an electrocatalyst and 10 to 50 wt % of a highly fluorinated ion-exchange polymer binder, said electrocatalyst being comprised of at least 40 wt % platinum, at least 15 wt % ruthenium, and 15 to 50 wt % particulate carbon wherein the platinum catalyst and ruthenium catalyst are supported on particulate carbon, and wherein the total loading of the metal in the anode is less than 3 mg/cm².

13. The process of claim 1 wherein the ionomeric polymer membrane is selected from the group consisting of cast membrane, extruded membrane, and a mixture thereof.

14. A fuel cell comprising the catalyst coated membrane of claim 1.

15. The fuel cell of claim 15 wherein the fuel cell is selected from the group consisting of hydrogen fuel cells, reformate fuel cells and direct methanol fuel cells.

16. The direct methanol fuel cell of claim 15 having a current density of at least 90 mW/cm².
